(19) United States
(12) Patent Application Publication
(10) Pub. No.: US 2009/0083929 A1
(43) Pub. Date: Apr. 2, 2009

(54) WINDSHIELD WIPER WITH BRUSHES AND TWO WIPER BLADES

(76) Inventor: Bang Jiang PENG, Scarborough (CA)

Correspondence Address: SINORICA, LLC, 528 FALLSGROVE DRIVE, ROCKVILLE, MD, 20850, US

(21) Appl. No.: 12/202,424

(22) Filed: Sep. 1, 2008

Related U.S. Application Data
(60) Provisional application No. 60/995,453, filed on Sep. 27, 2007.

(51) Int. Cl. B60S 1/38

(52) U.S. Cl. 15/250.41

(57) ABSTRACT

This invention relates to a windshield wiper comprises three layers of wiping surfaces by two wiper blades and multiple brushes.

### FIELD OF INVENTION

This invention relates to a windshield wiper with brushes and multiple wiper blades for improving the cleaning functions.

### SUMMARY OF THE INVENTION

A traditional windshield wiper includes a wiper blade for wiping off the obstructions. The efficiency of removing the obstructions mainly relies on the contacting surfaces of the wiper blades that moves along in two directions. When the aging effect of the wiper blade occurs or when the obstructions are heavily buildups, the wiper blade may not be tough enough to remove the obstructions.

The current invention discloses a windshield wiper that includes two wiper blades and multiple brushes assembled together in order to reinforce the strength of wiping function of a windshield wiper.

### BRIEF DESCRIPTION OF THE DRAWINGS

FIG. 1 shows the structure and elements of the current invention.

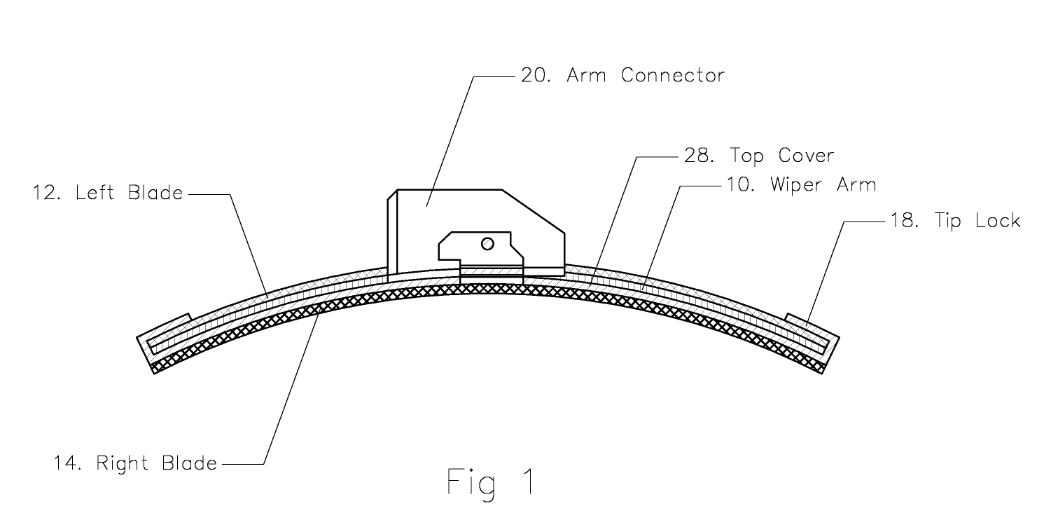

FIG. 2 shows the assembly of the wiper arm, right wiper blade, the left wiper blade, and the brushes.

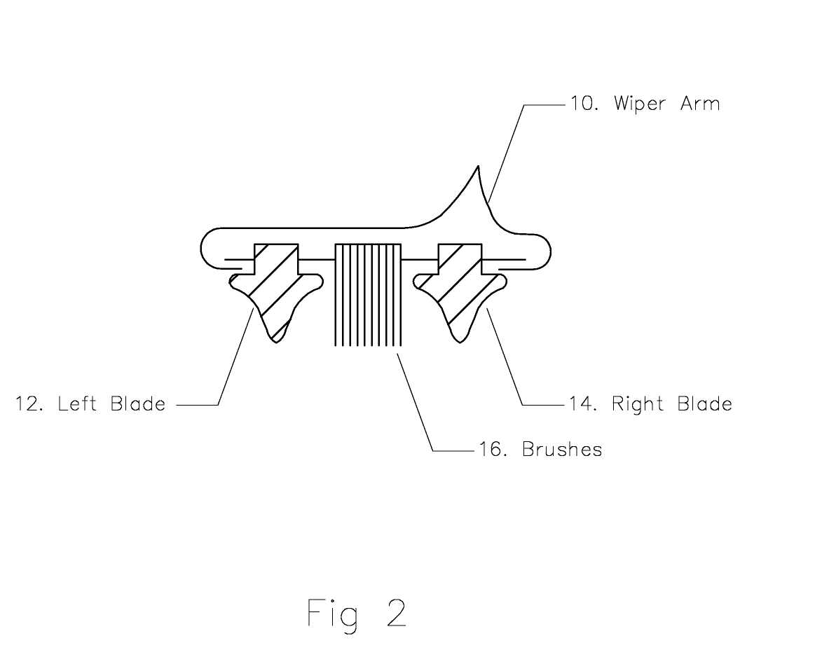

FIG. 3 shows the wiper arm with right blade groove, left blade groove, and the brush groove.

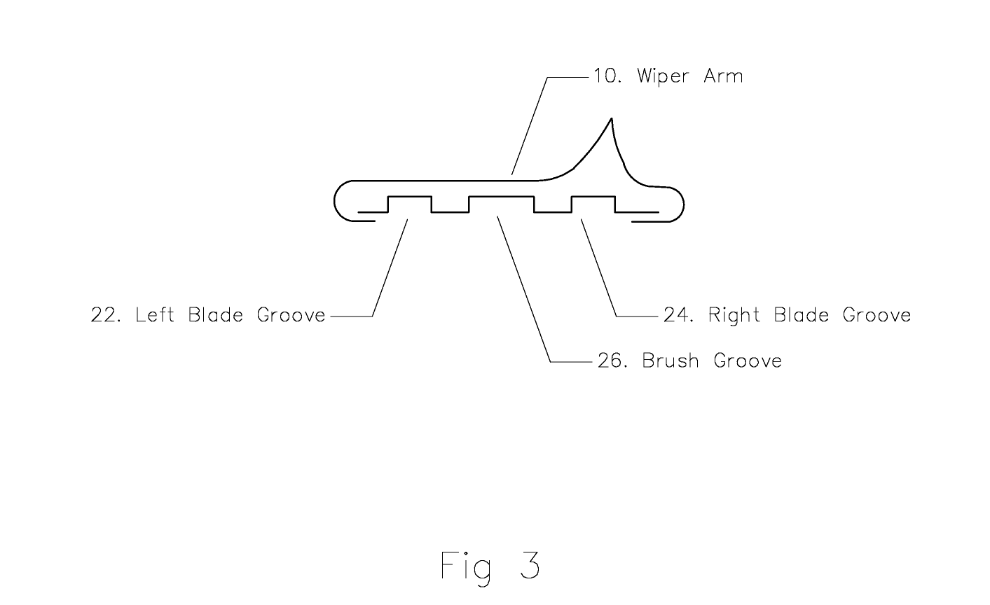

### DETAIL DESCRIPTIONS OF THE INVENTION

The present invention comprises two wiper blades 12, 14—a right blade 14 and a left blade 12, a wiper arm 10, a plurality of brushes 16, a top cover 28, two tip locks 18, an arm connector 20.

The wiper arm 10 comprises a left blade groove 22, a right blade groove 24, and a brush groove 26. The length of each groove is same as the length of the wiper arm 10. The right blade 14, with the same length as the wiper arm, is inserted into the right blade groove 22 and the left blade 12, with the same length of the wiper arm, is inserted into the left blade groove 22 respectively. Each blade is fixed in its groove and both blades are in parallel along with their lengthwise direction. A brush groove 26 is manufactured on the wiper arm and is in between the right blade groove and the left blade groove with the same length of the wiper arm. A plurality of brushes 16 are inserted and fixed into the brush groove 26. The wiper arm is therefore assembled with three layers of wiping surfaces contributed by two wiper blades and brushes when the wiper arm move on one direction.

A top cover 28 encloses the top portion of the assembly of wiper arm, two wiper blades, and the brushes. The top cover encloses only the top portion of the assembly so that the lower portion has enough wiping surface for removing the obstructions.

There are two tip locks 18 enclosing and attaching to the two ends of the assembly for securing the elements of the assembly.

An arm connector 20 is attached to the wiper arm for connecting the assembly and the wiper shaft (not shown) for pivoting the assembly.

1. A windshield wiper comprising:
a wiper arm comprises a right blade groove, a left blade groove, and a brush groove, wherein
length of the right blade groove, length of the left blade groove, and length of the brush groove respectively is same as length of the wiper arm;
the right blade groove, the left blade groove, and the brush groove are in parallel along lengthwise of the wiper arm; and
the brush groove is formed in between the right blade groove and the left blade groove;
a right wiper blade is inserted into the right blade groove;
a left wiper blade is inserted into the left blade groove;
a plurality of brushes are inserted into the brush groove;
a top cover encloses top portion of assembly of the wiper arm, right wiper blade, left wiper blade, and the brushes;
two tip locks enclose two ends of the assembly respectively; and
an arm connector attached to the wiper arm.
